(19) United States
(12) Patent Application Publication
(10) Pub. No.: US 2023/0070310 A1
(43) Pub. Date: Mar. 9, 2023

(54) ADDITIVE MANUFACTURED PART WITH ENHANCED RIGIDITY AND METHOD OF MANUFACTURING THE SAME

(71) Applicant: A.M. Toolbox, LLC, Powell, OH (US)

(72) Inventor: Jared Crooks, Powell, OH (US)

(21) Appl. No.: 18/049,396

(22) Filed: Oct. 25, 2022

Related U.S. Application Data
(63) Continuation-in-part of application No. 17/667,631, filed on Feb. 9, 2022.
Application No. 17/667,631 is a continuation of application No. 17/251,887, filed on Dec. 14, 2020, now Pat. No. 11,247,399.
(60) Provisional application No. 62/900,830, filed on Sep. 16, 2019.
(60) Provisional application No. 62/844,142, filed on May 7, 2019.

(51) Int. Cl. B29C 64/30; B33Y 10/00; B29C 64/165; B33Y 40/20

(52) U.S. Cl. CPC B29C 64/30; B33Y 10/00; B29C 64/165; B33Y 40/20; B29K 2063/00

(57) ABSTRACT

A method is provided, comprising: forming a porous body from an additive manufacturing powder and binder mixture, the porous body including opposing surface portions comprising top and bottom surface portions; placing the porous body on a vacuum table, wherein the vacuum table causes a negative air pressure within the porous body; and applying a tooling gel coat to the top surface portion, wherein the tooling gel coat is drawn into the porous body by the negative air pressure. In another aspect, a RTM tool is provided, comprising: a cavity and a core; wherein the cavity and the define a hollow; wherein the cavity and the core are formed as a porous body, wherein the cavity and core include a forming surface, wherein the cavity and core are each placed upon a vacuum table after which a tooling gel coat is applied to the forming surface.

### CROSS-REFERENCE TO RELATED APPLICATIONS

This application claims priority to U.S. application Ser. No. 17/667,631, filed Feb. 9, 2022, which is a continuation of U.S. Pat. No. 11,247,399, issued Feb. 15, 2022, which is a national stage entry of PCT Application No. PCT/US2020/031589, filed May 6, 2020, which claims priority to U.S. Provisional Patent Application No. 62/844,142, filed May 7, 2019, and U.S. Provisional Patent Application No. 62/900,830, filed Sep. 16, 2019, each of which is incorporated by reference herein in its entirety.

### BACKGROUND

An additive manufacturing process can form a part by depositing powder in successive layers that together define the shape of the finished part. A binder material is deposited with the powder to support and retain the powder in the desired shape. In some instances, sand is used as the powder.

Parts can be used as tools to form other parts. For example, tools may include vacuum form tooling, composite tooling, injection mold tooling, blow mold tooling, rotational mold tooling, compression mold tooling, extrusion mold tooling, thermoform tooling, and the like. Parts can also be used as trimming fixtures. Parts may be used for a resin transfer molding (“RTM”) process.

### SUMMARY

In one aspect, a method is provided, comprising: forming a porous body from an additive manufacturing powder and binder mixture in an additive manufacturing process, the porous body including opposing peripheral surface portions comprising a top surface portion and a bottom surface portion; placing the porous body on a vacuum table with the top surface portion oriented upward, wherein the vacuum table causes a negative air pressure within the porous body; and applying a tooling gel coat to the top surface portion, wherein the tooling gel coat is drawn into the porous body by the negative air pressure.

In another aspect, a resin transfer molding tool is provided, comprising: a cavity; and a core; wherein the cavity and the core correspond to one another and define a hollow; wherein the cavity and the core are each formed as a porous body from an additive manufacturing powder and binder mixture, wherein the cavity and core each include a forming surface, and wherein the cavity and core are each placed upon a vacuum table after which a tooling gel coat is applied to the forming surface.

In another aspect, a method for molding and trimming a part is provided, comprising: providing: a cavity; a core; and a trimming fixture; wherein the cavity and the core correspond to one another and define a hollow; wherein the trimming fixture is formed as a porous body from an additive manufacturing powder and binder mixture, and wherein the trimming fixture is placed upon a vacuum table after which a molded part formed using the cavity and the core is placed upon the trimming fixture.

### BRIEF DESCRIPTION OF THE DRAWINGS

FIG. 1 is a flow chart of steps taken in a method 100 of forming an additive manufactured part.

FIG. 2 is a flow chart of steps taken in a method 200 of forming an additive manufactured part.

FIG. 3A is a partial sectional view of an additive manufactured part 300 infused with a tooling gel coat 311.

FIG. 3B is a partial sectional view of additive manufactured part 300 infused with a tooling gel coat 311 and coupled with a negative pressure chamber 314.

FIG. 4A is a partial sectional view of an additive manufactured part 400.

FIG. 4B is a partial sectional view of additive manufactured part 400 infused with a first tooling gel coat 411A and coupled with a negative pressure chamber 414.

FIG. 4C is a partial sectional view of additive manufactured part 400 infused with a resin 410.

FIG. 4D is a partial sectional view of additive manufactured part 400 infused with a second tooling gel coat 411B.

FIG. 5A is a view of tool 500 for mixing a two-part resin and/or coating while introducing an inert gas into the mixture.

FIG. 5B is a view of tool 500 for mixing a two-part resin and/or coating while introducing an inert gas into the mixture.

FIG. 5C is a sectional view of tool 500 for mixing a two-part resin and/or coating while introducing an inert gas into the mixture.

FIG. 6 is a flow chart of steps taken in a method 600 of forming an additive manufactured part.

FIG. 7A is an upper perspective view of a resin transfer molding (“RTM”) tool 700.

FIG. 7B is an elevation view of RTM tool 700.

FIG. 7C is a partially exploded view of RTM tool 700.

FIG. 7D is a sectional view of RTM tool 700.

FIG. 7E is a partially exploded view of RTM tool 700 including a reinforcement material 751.

FIG. 7F is a sectional view of RTM tool 700 including a reinforcement material 751.

FIG. 8A is an elevation view of a system 800 for molding a part 864.

FIG. 8B is a lower perspective view of system 800 for molding a part 864.

FIG. 8C is a partial sectional view of system 800 where part 864 is placed upon a trimming fixture 868 connected to a vacuum table 870.

FIG. 8D is a partial sectional view of system 800 where part 864 is placed upon trimming fixture 868 connected to a vacuum table 870.

FIG. 8E is a partial sectional view of system 800 where part 864 is placed upon trimming fixture 868 connected to a vacuum table 870.

FIG. 8F is a partial sectional view of system 800 where part 864 is placed upon trimming fixture 868 and trimmed with a cutter 880.

FIG. 8G is a partial sectional view of system 800 where part 864 is placed upon trimming fixture 868 and trimmed with cutter 880.

FIG. 811 is a perspective view of trimmed part 864.

### DETAILED DESCRIPTION

The apparatus illustrated in the drawings includes structures that are examples of the elements recited in the apparatus claims and can be employed to perform the steps recited in the method claims. The illustrated apparatus thus includes examples of how a person of ordinary skill in the art can make and use the claimed invention. These examples are described to meet the written description and enablement requirements of the patent statute without imposing limitations that are not recited in the claims. One or more elements of one aspect may be used in combination with, or as a substitute for, one or more elements of another aspect as needed for any particular implementation of the claimed invention.

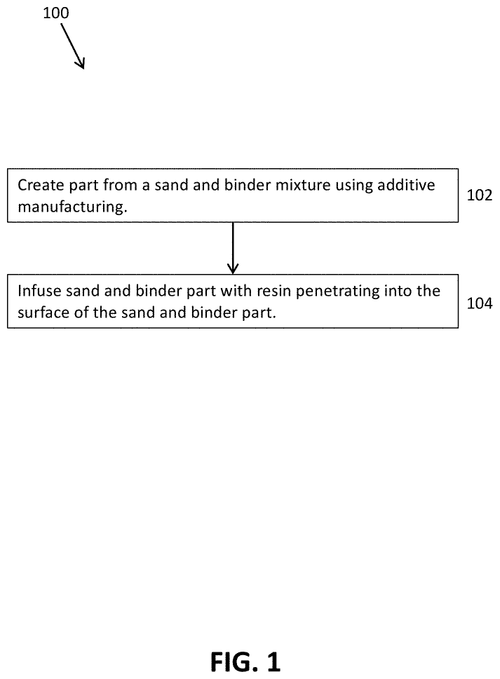

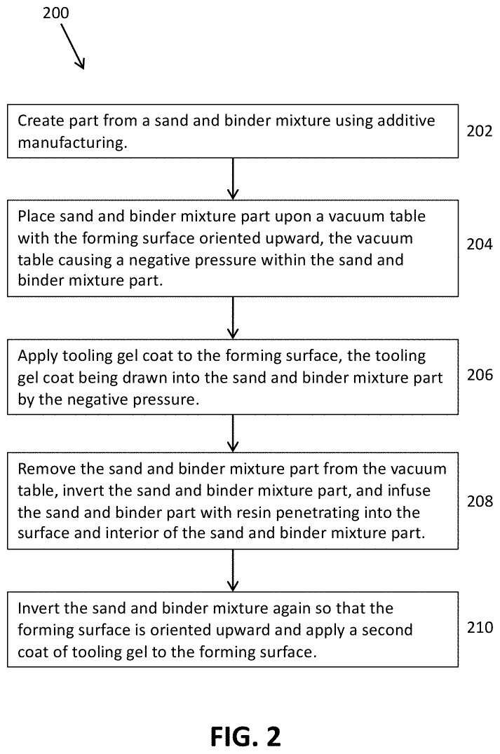

As shown in FIGS. 1 and 2, methods of forming and using an additive manufactured part can be performed in the steps summarized. The additive manufactured part may be formed as a solid body of material including additive manufacturing powder (e.g., a sand) and a binder material supporting the powder in the shape of the solid body.

Method 100 may include the following steps: create part from a sand and binder mixture using additive manufacturing (102) and infuse sand and binder part with resin penetrating into the surface of the sand and binder part (104).

Method 200 may include the following steps: Create part from a sand and binder mixture using additive manufacturing (202); place sand and binder mixture part upon a vacuum table with the forming surface oriented upward, the vacuum table causing a negative pressure within the sand and binder mixture part (204); apply tooling gel coat to the forming surface, the tooling gel coat being drawn into the sand and binder mixture part by the negative pressure (206); remove the sand and binder mixture part from the vacuum table, invert the sand and binder mixture part, and infuse the sand and binder part with resin penetrating into the surface and interior of the sand and binder mixture part (208); and invert the sand and binder mixture again so that the forming surface is oriented upward and apply a second coat of tooling gel to the forming surface (210).

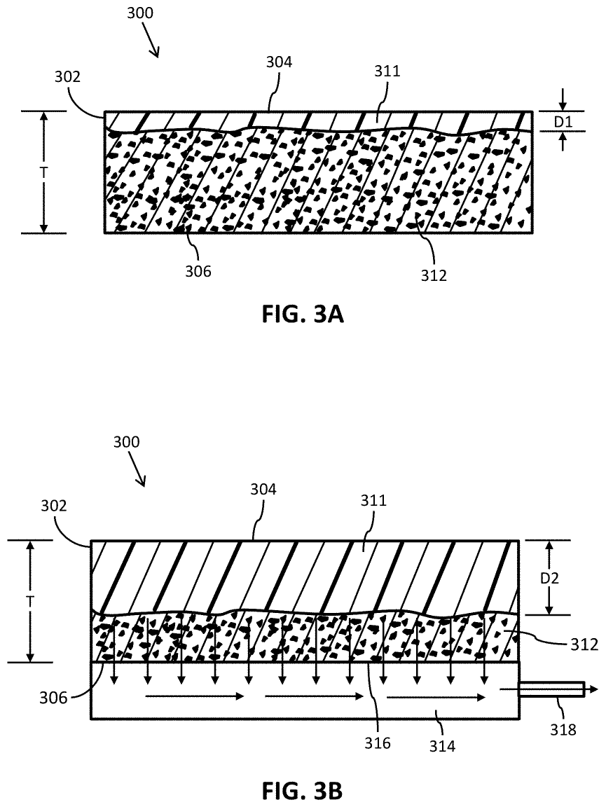

FIG. 3A is a partial sectional view of an additive manufactured part 300 infused with a tooling gel coat 311 via gravity pulling tooling gel coat 311 into the green sand/binder material 312 to a depth (D1). FIG. 3B illustrates the increased infusion depth (D2) of tooling gel coat 311 upon application of a negative pressure chamber 314 to the underside of part 300, relative to that shown in FIG. 3A, which has a lesser infusion depth (D1).

The illustrated section 302 of the part 300 has a thickness T between opposed peripheral surface portions 304 and 306. A tooling gel coat 311 is infused inwardly from one of the opposed surface portions 304 (e.g, a forming surface), and penetrates the green sand/binder material 312 to a depth D1, D2 that is less that the thickness T. The infused tooling gel 311 could alternatively penetrate through the entire thickness T.

Tooling gel coat 311 is applied to a forming surface of part 300 to provide a smoother finish against which another part, such as a polymer, may be molded. Tooling gel coat 311's smooth surface resists adhesion to the molded part. Additionally, tooling gel coat 311 may be capable of withstanding the elevated temperatures commonly experienced during the molding of parts.

However, when tooling gel coat 311 is unable to penetrate sufficiently into the green sand/binder material 312 (e.g., to a depth D1), the molded part may adhere to the tooling gel coat 311 enough to pull some or all of tooling gel coat 311 away from green sand/binder material 312, which requires a user to replace/repair that portion of tooling gel coat 311, resulting in delays, additional work, and tool downtime. FIG. 3A illustrates a tooling gel coat 311 applied simply via gravity pulling tooling gel coat 311 into green sand/binder material 312 to a limited depth D2.

FIG. 3B, on the other hand, uses negative pressure chamber 314 applied to the underside of green sand/binder material 312 to draw tooling gel coat 311 much deeper into green sand/binder material 312 to a depth D2. Green sand/binder material 312 is sufficiently porous to cause ambient air to flow into and through green sand/binder material 312 from surface portion 304 to surface portion 306. This air flow is the result of a negative gauge air pressure generated by negative pressure chamber 314 causing a pressure differential between surface portions 304 and 306. Tooling gel coat 311 is drawn deeper into green sand/binder material 312 as a result of this air flow and pressure differential, to a depth D2.

Depth D2 is greater than depth D1. Depth D2 may be, or is, at least twice that of depth D1. Depth D2 may be, or is, at least three times that of depth D1. Depth D2 may be, or is, at least four times that of depth D1. Depth D2 may be, or is, at least five times that of depth D1. Depth D2 may be, or is, at least six times that of depth D1. Depth D2 may be, or is, at least seven times that of depth D1. Depth D2 may be, or is, at least eight times that of depth D1. Depth D2 may be, or is, greater than eight times that of depth D1. In one example, depth D1 is about 1/16″ (1.59 mm) while depth D2 is ¼″ (6.35 mm).

Negative pressure chamber 314 may include a surface 316 having at least one air inlet fluidically connected to at least one air outlet 318. Surface 316 may include a plurality of air inlets fluidically connected to the at least one air outlet 318. An air pump or the like may be used to cause negative pressure chamber 314 to generate a negative gauge air pressure at the at least one air inlet, wherein the negative gauge air pressure is less than the air pressure of the ambient air.

Tooling gel coat 311 may be a two-part coating as described further below.

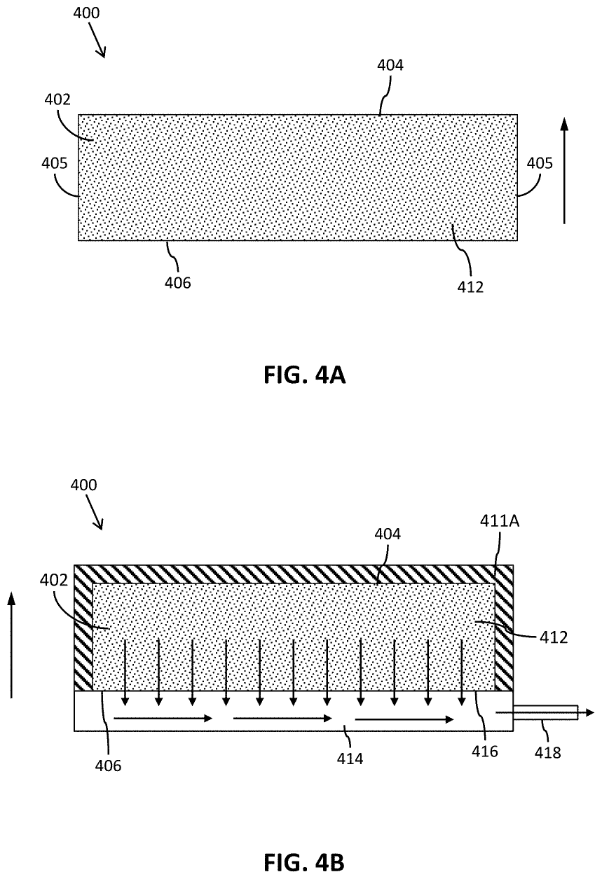

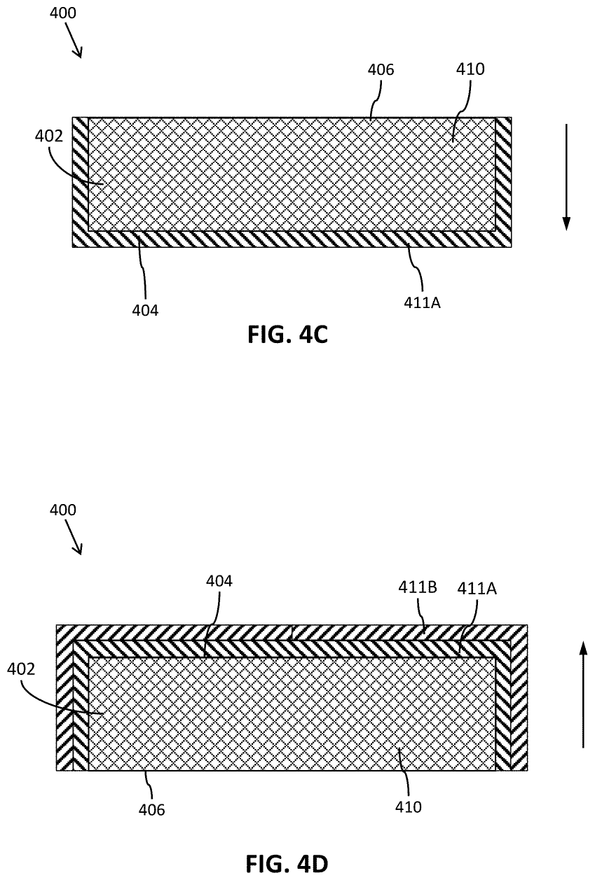

FIGS. 4A-4D illustrate a partial sectional view of an additive manufactured part 400.

Part 400 and the illustrated section 402 is initially formed from a green sand/binder material 412 having opposed peripheral surface portions 404 and 406. For ease in explanation, surface portion 404 will be referred to as the top surface portion, and surface portion 406 will be referred to as the bottom surface portion. Peripheral side portions 405 are oriented between top surface portion 404 and bottom surface portion 406. An arrow in FIG. 4A is directed to indicate that illustrated section 402 is in the upright configuration.

FIG. 4B is a partial sectional view of additive manufactured part 400 infused with a first tooling gel coat 411A and coupled with a negative pressure chamber 414. Illustrated section 402 is placed upon a vacuum table comprising a negative pressure chamber 414 having a surface 416 with at least one air inlet fluidically connected to at least one air outlet 418. Tooling gel coat 411A is applied to and drawn into top surface portion 404 and side portions 405, as described above with respect to FIG. 3B.

FIG. 4C is a partial sectional view of additive manufactured part 400 infused with a resin 410. Illustrated section 402 of part 400 is removed from surface 416, inverted, and placed with bottom surface portion 406 up. A resin 410 is applied to green sand/binder material 412, which due to its porous nature, can accept resin 410 due to gravitational forces and wicking of resin 410. Resin 410 may be a two-part resin as described further below.

FIG. 4D is a partial sectional view of additive manufactured part 400 infused with a second tooling gel coat 411B. Illustrated section 402 of part 400 is again inverted and placed with top surface portion 404 up. A second coat of tooling gel coat (tooling gel coat 411B) is applied over tooling gel coat 411A. Tooling gel coat 411B is then optionally sanded and polished to achieve the forming surface smoothness as desired for use of part 400 in molding other parts.

Part 400 is particularly well suited for use as a mold due to the increased penetration depth of tooling gel coat 411A, which both aids in mold removal and tolerance to the high temperatures of molding, as well as due to infusion with resin 410, which adds significant compressive and tensile strength to part 400.

Tooling gel coat 411A, 411B may be a two-part coating as described further below.

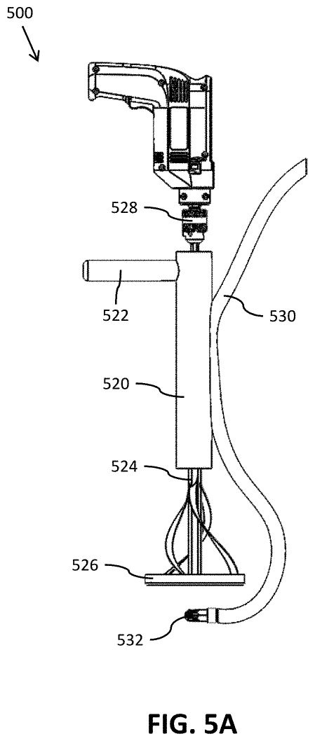

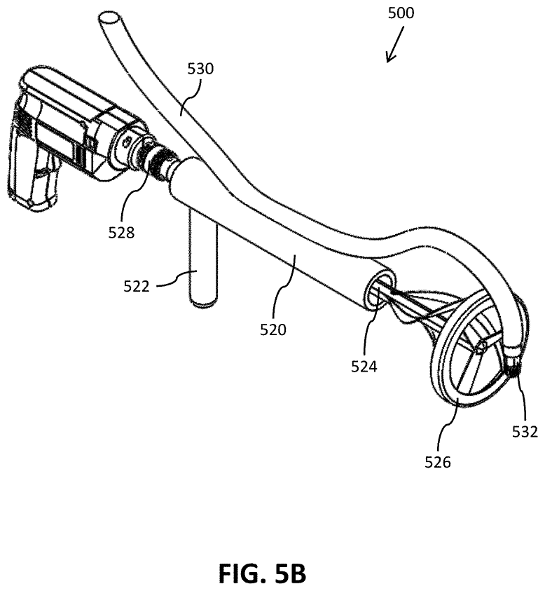

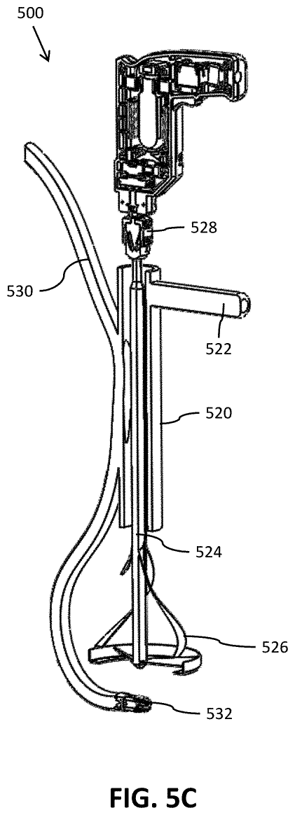

FIGS. 5A-5C illustrate a mixing tool 500 a two-part resin and/or coating while introducing an inert gas into the mixture. The two-part resin may be resin 410. The two-part coating may be tooling gel coat 311, 411A, 411B.

Mixing tool 500 may include a housing 520. Housing 520 may include a handle 522 configured to be grasped by a user's hand for manipulation of the mixing tool 500.

The housing 520 may include a hollow bore, and within the hollow bore of the housing 520 may extend a mixing shaft 524. The mixing shaft 524 may be rotatably attached to the housing 520, for example, via one or more ball bearing. The mixing shaft 524 is configured to rotate independently of the housing 520. The distal end of the mixing shaft 524 may include a mixing head 526. The mixing head 526 may be any of a variety of devices configured to mix elements, including for example, the two parts (e.g., a resin and a hardener) of a two-part resin and/or two-part coating.

The mixing tool 500 may include a rotation-inducing device 528. The rotation-inducing device 528 is capable of rotating the mixing shaft 524 and the mixing head 526 connected to the distal end of the mixing shaft 524. The rotation-inducing device 528 may engage the proximate end of the mixing shaft 524.

The mixing tool 500 may include an air line 530. The air line 530 may be a flexible tube configured to introduce an inert gas to a mixture, including for example to the mixture of the two parts (e.g., a resin and a hardener) of a two-part resin and/or two-part coating. During mixing of the two parts by the mixing head 526, a user of the mixing tool 500 may cause an inert gas to flow through the air line 530 and out of a nozzle 532 attached to the distal end of the air line. The inert gas may be one or both of nitrogen and argon. The nozzle 532 may be oriented to direct the inert gas toward the mixing head 526, such that the inert gas is introduced directly to the site of mixing of the elements. Alternatively, the nozzle 532 may be oriented to direct the inert gas just below the mixing head 526, such that the inert gas is introduced below the site of the mixing and bubbles up through the site of the mixing of the elements.

The introduction of an inert gas during mixing may increase the glass transition, or Tg, of the two-part resin and/or two-part coating. The introduction of an inert gas during mixing may increase the Tg of the two-part resin and/or two-part coating by up to 30% of the manufacturer's stated Tg of the resin and/or coating. The increase of the Tg may be as a result of the introduction of the inert gas creating a mixing cyclone effect that helps to uniformly mix the two parts (e.g., a resin and a hardener) of the two-part resin and/or coating to achieve the maximum Tg potential in those materials.

The introduction of an inert gas may be included in any of the aforementioned methods of making a mold tool, including for example methods 100 and 200. In practice, a part formed from a powder (such as sand) and binder mixture is infused with a resin, which penetrates into the surface of the part. The resin may be a two-part resin that is mixed while an inert gas is applied to the resin as described above. Once mixed, the resin is applied to the sand and binder part on a first side (e.g., top) of the part. The resin is allowed to cure for a period of time (e.g., 24 hours), after which the part may be inverted and resin may be applied to the sand and binder part on a second side (e.g., bottom) of the part. The resin is allowed to cure for a period of time (e.g., 24 hours). At this point, the part is approximately as hard as cement.

A surface treatment, such as a two-part coating, may be applied to the part following application and curing of the resin. The two-part coating may be a tooling gel coating. The two-part coating may be mixed while an inert gas is introduced to the mixture as described above. The coating may be applied to the part (where the part is a mold tool, the coating may be applied to the forming surface). The coating is allowed to cure for a period of time (e.g., 24 hours), and the process is complete. Optionally, one may apply a fine particle, such as sand blasting material, to the coating after it is applied but before it is cured. The addition of the fine particle adds a texture to the final tool surface.

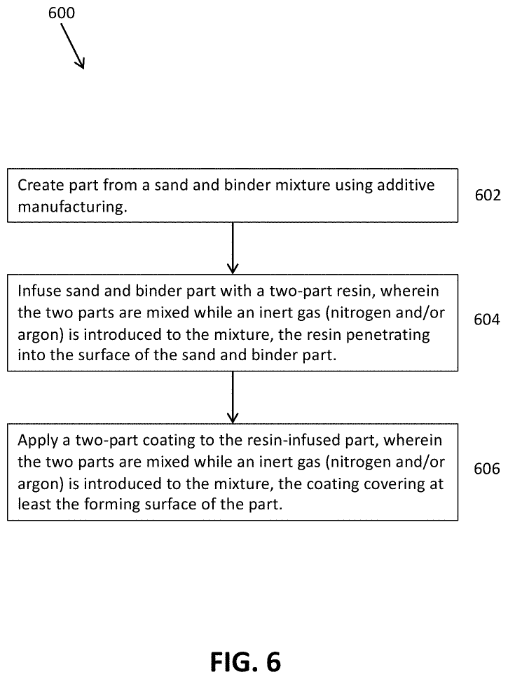

FIG. 6 is a flow chart of steps taken in a method 600 of forming an additive manufactured part. Method 600 may include the following steps: create part from a sand and binder mixture using additive manufacturing (602); infuse sand and binder part with a two-part resin (e.g., resin 410), wherein the two parts are mixed while an inert gas (nitrogen and/or argon) is introduced to the mixture, the resin penetrating into the surface of the sand and binder part (604); and apply a two-part coating (e.g., tooling gel coat 311, 411A, 411B) to the resin-infused part, wherein the two parts are mixed while an inert gas (nitrogen and/or argon) is introduced to the mixture, the coating covering at least the forming surface of the part (606).

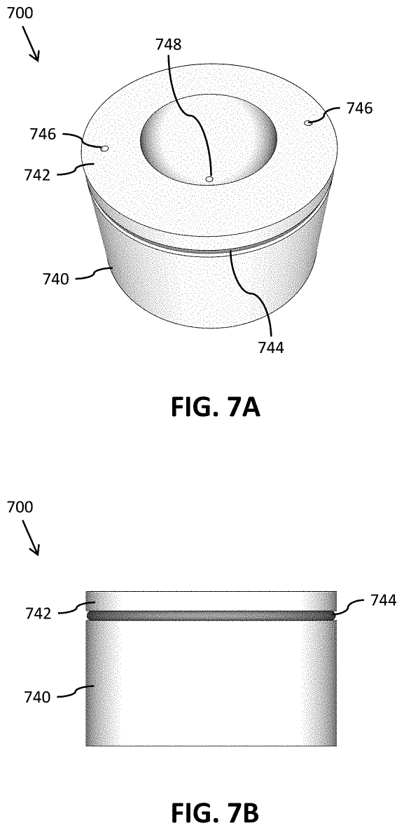

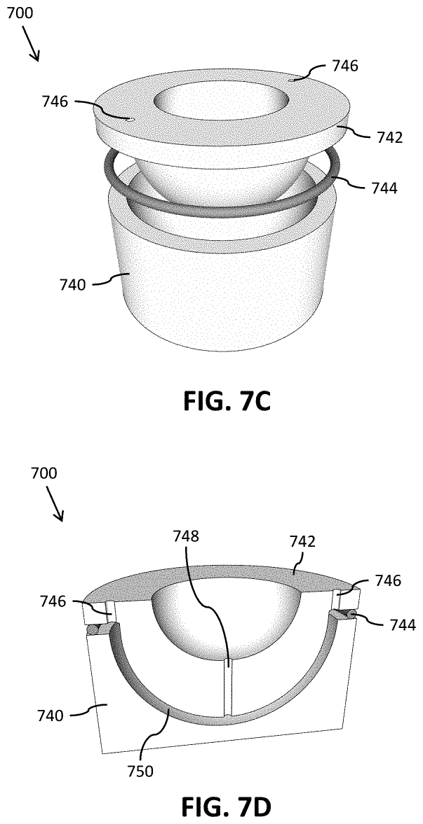

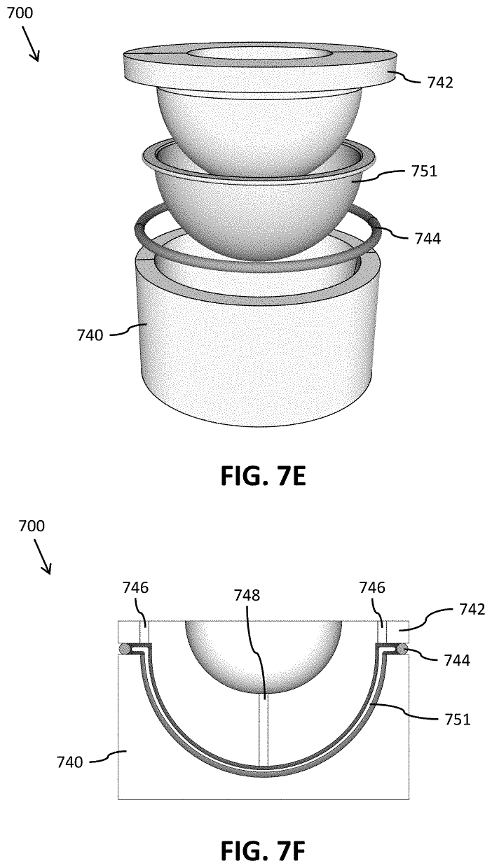

FIGS. 7A-7F illustrate a resin transfer molding (“RTM”) tool 700. Additive manufactured part 300, 400 may be used as an RTM tool. RTM tool 700 may be produced using any of methods 100, 200, and 600.

RTM tool 700 may include a cavity 740 and a core 742. Cavity 740 may also be referred to as an “A-side” while core 742 may also be referred to as a “B-side.” Cavity 740 and core 742 correspond to one another and may nest with one another to form a hollow 750 (that is, a volume/cavity open to accept a material) into which a material may be injected to create a molded part. Cavity 740 and core 742 each include a forming surface, which form the bounds of hollow 750.

A seal 744 is oriented between cavity 740 and core 742, adjacent to hollow 750, to contain the injected material within hollow 750 to mold the desired molded part. Seal 744 helps ensure that resin injected into hollow 750 does not escape hollow 750 in a significant manner except for from vent 748.

RTM tool 700 may include at least one resin injection port 746, and at least one vent 748. Both at least one resin injection port 746 and at least one vent 748 are fluidically connected to hollow 750, and to one another. At least one resin injection port 746 may be used to inject a resin into hollow 750, while vent 748 may be used to allow air within hollow 750 to escape hollow 750, and permit hollow 750 to be completely filled with the resin.

The injected resin may be dicyclopentadiene (“DCPD”) resin. The injected resin may be a two-part resin. Resin injected into at least one injection port 746, and thus into hollow 750, reacts and generates heat. For example, the injected resin within hollow 750 may reach temperatures as great as 400 degrees Fahrenheit (204 degrees Celsius), or greater. As described above with respect to tooling gel coat 311, 411A, 411B, tooling gel used in RTM tool 700 may be capable of withstanding the elevated temperatures of resins such as DCPD during their reaction. The deep penetration of the high temperature resistant tooling gel coat 311, 411A results in RTM tool 700 being particularly well-suited to long tool life and able to withstand the high resin reaction temperatures without destruction of RTM tool 700.

Optionally, a layer of a reinforcement material 751, e.g., a fabric/textile), or other reinforcement material, may be placed within hollow 750 prior to injection of the resin into hollow 750, resulting in a molded part formed as a composite of the injected resin and reinforcement material 751.

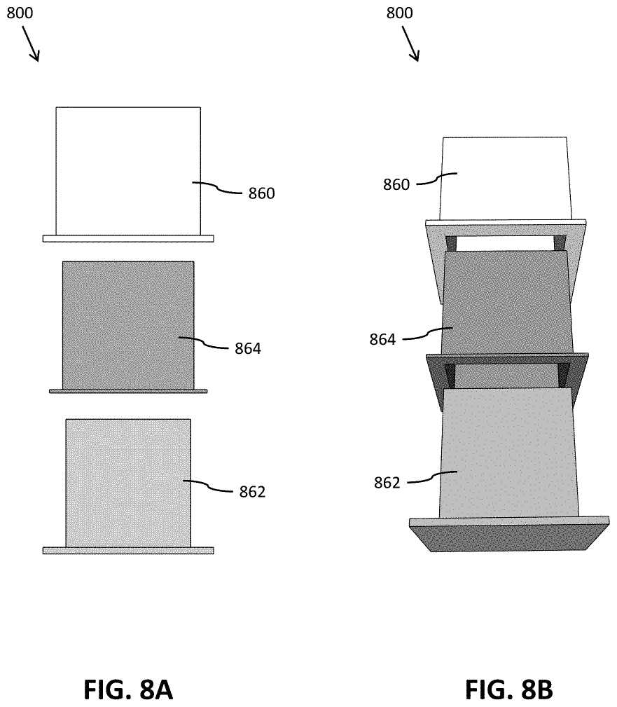

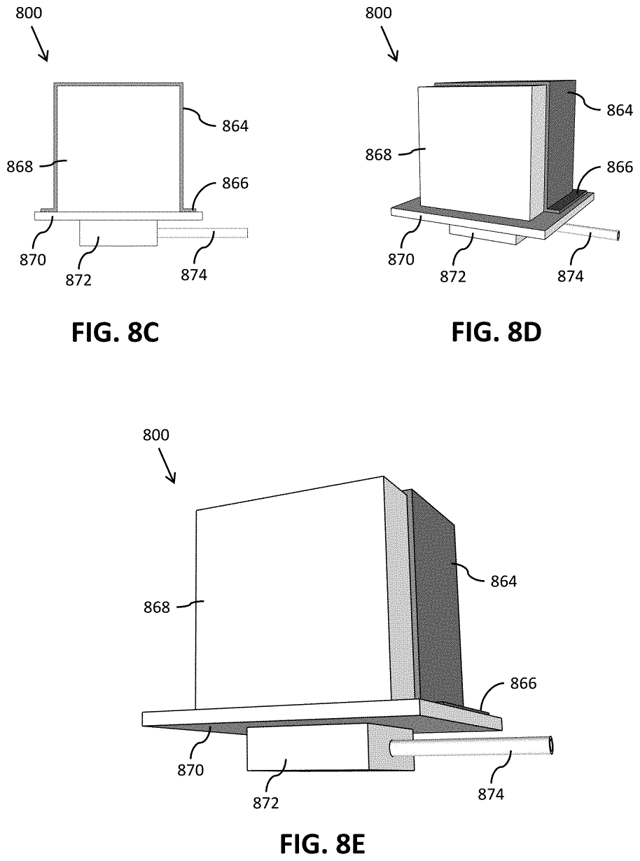

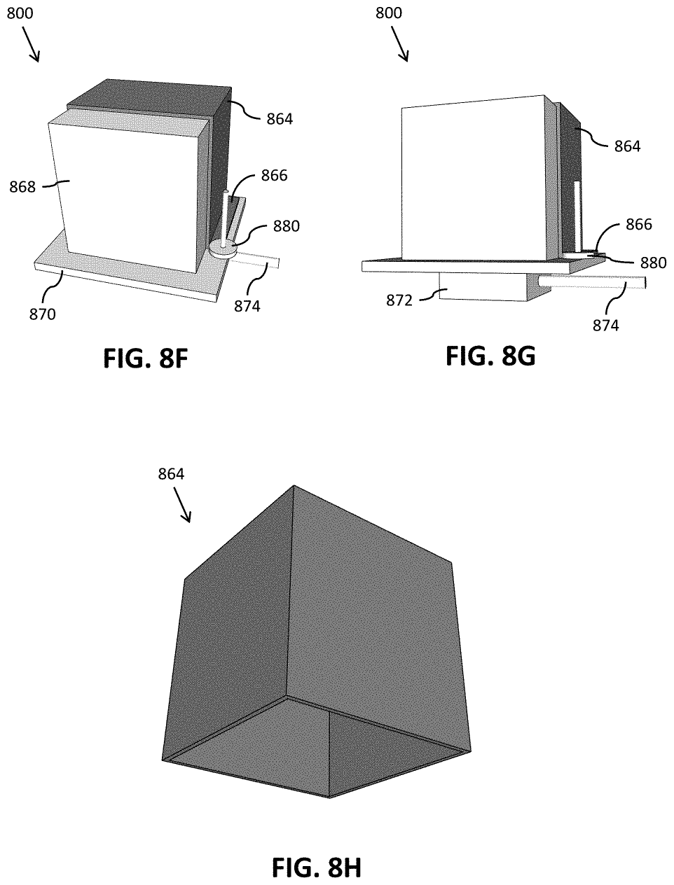

FIGS. 8A-81I illustrate a system 800 for molding and trimming a part 864. System 800 includes a cavity 860 and a core 862 that together are used to form a molded part 864. Molded part 864 may be formed by the injection of a resin into a hollow formed between cavity 860 and core 862.

As illustrated in FIGS. 8C-8G, a trimming fixture 868 is formed in the same general shape and dimensions as core 862. Trimming fixture 868 may be formed from a green sand/binder material (such as green sand/binder material 312, 412) without the addition of a resin or tooling gel coat. Trimming fixture 868 may be placed upon a vacuum table comprising a negative pressure chamber 872 having a surface 870 with at least one air inlet fluidically connected to at least one air outlet 874. The green sand/binder material of trimming fixture 868 is sufficiently porous to cause ambient air to flow into and through trimming fixture 868 from its peripheral surface portions to surface 870 and at least one air inlet. This air flow is the result of a negative gauge air pressure generated by negative pressure chamber 872 causing a pressure differential between the trimming fixture 868′s peripheral surface portions and surface 870.

Molded part 864 is placed upon trimming fixture 868, which fits perfectly as trimming fixture 868 is formed in the same general shape and dimensions as core 862 that was used to mold molded part 864, and fixed to trimming fixture 868 via the pressure differential caused by negative pressure chamber 872. Molded part 864 may be fixed to trimming fixture 868 for the purpose of post-molding processing of molded part 864, including the trimming of sprue/flash 866 using a cutter 880.

FIG. 811 illustrates trimmed part 864 after removal of sprue/flash 866.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of aspects thereof, and while the aspects have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

What is claimed is:

1. A method comprising:
forming a porous body from an additive manufacturing powder and binder mixture in an additive manufacturing process, the porous body including opposing peripheral surface portions comprising a top surface portion and a bottom surface portion;
placing the porous body on a vacuum table with the top surface portion oriented upward, wherein the vacuum table causes a negative air pressure within the porous body; and
applying a tooling gel coat to the top surface portion, wherein the tooling gel coat is drawn into the porous body by the negative air pressure.

2. The method of claim 1, further comprising:
removing the porous body from the vacuum table;
inverting the porous body such that the top surface portion is oriented downward; and
infusing the porous body with a resin penetrating into an interior of the porous body.

3. The method of claim 2, further comprising:
inverting the porous body such that the top surface portion is oriented upward; and
applying a second tooling gel coat to top surface portion.

4. The method of claim 1, wherein the porous body is a tool, and wherein the top surface portion is a forming surface.

5. The method of claim 2, wherein the resin is a two-part resin including a resin and a hardener.

6. The method of claim 5, wherein an inert gas is applied to the two-part resin during mixture of the resin and the hardener.

7. A resin transfer molding tool, comprising:
a cavity; and
a core;
wherein the cavity and the core correspond to one another and define a hollow;
wherein the cavity and the core are each formed as a porous body from an additive manufacturing powder and binder mixture,
wherein the cavity and core each include a forming surface, and
wherein the cavity and core are each placed upon a vacuum table after which a tooling gel coat is applied to the forming surface.

8. The resin transfer molding tool of claim 7, further comprising a resin infused into the porous body of each of the cavity and the core.

9. The resin transfer molding tool of claim 8, wherein the resin is a two-part resin including a resin and a hardener.

10. The resin transfer molding tool of claim 9, wherein an inert gas is applied to the two-part resin during mixture of the resin and the hardener.

11. The resin transfer molding tool of claim 7, further comprising a reinforcement material contained within the hollow.

12. The resin transfer molding tool of claim 11, wherein the reinforcement material is a textile.

13. The resin transfer molding tool of claim 7, wherein the cavity includes at least one of a vent and a resin injection port.

14. The resin transfer molding tool of claim 7, wherein the core includes at least one of a vent and a resin injection port.

15. A method for molding and trimming a part, comprising:
providing:
a cavity;
a core; and
a trimming fixture;
wherein the cavity and the core correspond to one another and define a hollow;
wherein the trimming fixture is formed as a porous body from an additive manufacturing powder and binder mixture, and
wherein the trimming fixture is placed upon a vacuum table after which a molded part formed using the cavity and the core is placed upon the trimming fixture.

16. The method of claim 15, wherein the molded part includes at least one of a sprue and a flash.

17. The method of claim 16, wherein the at least one of the sprue and the flash is trimmed from the molded part using a cutter.

18. The method of claim 15, wherein the vacuum table causes a negative air pressure within the porous body.

19. The method of claim 18, wherein the negative air pressure fixes the molded part to the trimming fixture.
